(19) United States
(12) Patent Application Publication
(10) Pub. No.: US 2014/0270310 A1
(43) Pub. Date: Sep. 18, 2014

(54) ACOUSTIC WAVEGUIDE FOR CONFERENCE PHONE REALTIME COMMUNICATIONS

(71) Applicant: Cisco Technology, Inc., San Jose, CA (US)

(72) Inventor: Kevin Lee Hughes, Frisco, TX (US)

(73) Assignee: Cisco Technology, Inc., San Jose, CA (US)

(21) Appl. No.: 14/205,266

(22) Filed: Mar. 11, 2014

Related U.S. Application Data
(60) Provisional application No. 61/777,133, filed on Mar. 12, 2013.

(51) Int. Cl. H04R 1/00

(52) U.S. Cl. CPC H04R 1/00
USPC 381/345

(57) ABSTRACT

In one embodiment, an apparatus includes a network interface, an acoustic waveguide, and an arrangement. The network interface is arranged to communicate on a network, and is further configured to obtain a signal from the network. The arrangement is configured to transform the signal into an acoustic wave and to provide the acoustic wave to the acoustic waveguide. The acoustic waveguide is configured to direct the acoustic wave in a path.

### CROSS-REFERENCE TO RELATED APPLICATION

The present application claims priority of U.S. Provisional Patent Application No. 61/777,133, filed Mar. 12, 2013, which is incorporated herein by reference in its entirety.

### TECHNICAL FIELD

The disclosure relates generally to network communications. More particularly, the disclosure relates to a method and apparatus for efficiently directing sound at listeners during realtime communications using a conference phone device.

### BACKGROUND

Conference phones are often used in relatively open environments, e.g., in a conference room or an office. Typically, loudspeakers of conference phones are direct radiation loudspeakers. A loudspeaker that is a direct radiator includes a diaphragm that is directly coupled to air. The acoustic output associated with a direct radiator is generally non-directional, e.g., the acoustic output is generally directed in a vertical direction and not in a horizontal direction.

### BRIEF DESCRIPTION OF THE DRAWINGS

The disclosure will be readily understood by the following detailed description in conjunction with the accompanying drawings in which:

FIG. 1 is a block diagram representation of a device that includes an acoustic waveguide in accordance with an embodiment.

FIG. 2 is a diagrammatic representation of a speaker arrangement in accordance with an embodiment.

FIG. 3 is a diagrammatic representation of a speaker arrangement, e.g., speaker arrangement 202 of FIG. 2, that has an associated microphone in accordance with an embodiment.

FIG. 4A is a block diagram side-view representation of a conference phone that includes an acoustic waveguide that directs sound in accordance with an embodiment.

FIG. 4B is a block diagram top-view representation of a conference phone that includes an acoustic waveguide, e.g., conference phone 430 of FIG. 4A, that directs sound in accordance with an embodiment.

FIG. 5 is a diagrammatic top-view representation of a phase plug, e.g., phase plug 116 of FIG. 2, in accordance with an embodiment.

FIG. 6 is a block diagram representation of a conference station that includes a speaker arrangement with an acoustic waveguide in accordance with an embodiment.

### DESCRIPTION OF EXAMPLE EMBODIMENTS

### General Overview

According to one aspect, an apparatus includes a network interface, an acoustic waveguide, and an arrangement. The network interface is arranged to communicate on a network, and is further configured to obtain a signal from the network. The arrangement is configured to transform the signal into an acoustic wave and to provide the acoustic wave to the acoustic waveguide. The acoustic waveguide is configured to direct the acoustic wave in a path.

### DESCRIPTION

Conference phones or speaker phones, e.g., conference stations such as an Internet Protocol (IP) conference station, are often used in meeting room environments to enable groups of people in the meeting room environments to participate in conference calls. As listeners in a meeting room environment are typically positioned around a conference station, the ability to direct sound from a loudspeaker of the conference station at the listeners would enhance the quality of sound perceived by the listeners. In addition, the ability to direct sound from a conference station at a listener, e.g., in a direct path to a listener, may reduce the amount of power used by the conference station, as loudspeaker sensitivity may be improved and sound may be directed at the listeners with improved efficiency and reduced distortion. A reduction in the amount of power due to increased acoustic efficiency may enable the size of a power amplifier used to power a conference station to be reduced.

By providing a realtime communications device such as a conference station that has a loudspeaker with an acoustic waveguide, sound waves produced by the loudspeaker may be directed towards a listener in a substantially direct path rather than in a primarily upward direction. In one embodiment, a conference station may have a loudspeaker, e.g., a loudspeaker mounted within the conference station, as well as a loudspeaker driver and a phase plug that is acoustically coupled to an acoustic waveguide. It should be appreciated that the loudspeaker driver may generally also be acoustically coupled to the acoustic waveguide. An acoustic waveguide is generally a structure which is configured to guide air or, more particularly, sound waves in the air. The shape of an acoustic waveguide may be configured, for example, to direct sound in at least one particular direction.

A conference station generally also includes a microphone, or a component which captures sound and allows the sound to be transmitted through the conference station to a party, e.g., a party using another conference station on a communications network. The placement of a microphone of a conference station relative to an acoustic waveguide of the conference station may vary. For example, a microphone may be positioned substantially above an acoustic waveguide arranged to improve echo-cancellation, and a microphone may be positioned substantially below an acoustic waveguide to reduce cone filtering.

The power requirements of a conference station which includes an acoustic waveguide may be less than the power requirements of a conference station which does not include an acoustic waveguide. As an acoustic waveguide directs sound in a direct path to a user of the conference station, e.g., a conference call participant, power requirements may be reduced as loudspeaker sensitivity is improved and sound may be provided to the user more efficiently. By way of example, by directing frequencies of approximately one kilohertz (kHz) and higher in a path at a user, sound may efficiently be provided to the user.

Referring initially to FIG. 1, a realtime communications device that includes an acoustic waveguide will be described in accordance with an embodiment. A realtime communications device 100, e.g., a conference station, includes a loudspeaker 108 and an enclosure 104. At least one loudspeaker driver 112, a phase plug 116, and an acoustic waveguide 120 may be contained within enclosure 104. Typically, loudspeaker 108 and at least one loudspeaker driver 112 may be considered to be an overall loudspeaker.

Loudspeaker 108 may generally be a transducer such as compression-loaded transducer, and cooperates with at least one loudspeaker driver 112 to convert a signal, as for example an electrical audio signal, into acoustic waves. In the described environment, the acoustic waves may be guided by acoustic waveguide 120. At least one loudspeaker driver 112 is typically included in device 100 to effectively reproduce different frequency ranges from an obtained signal. In general, substantially separate loudspeaker drivers 112 may include, but are not limited to including a relatively high frequency driver such as a tweeter, relatively low frequency drivers such as woofers and subwoofers, and a mid-range frequency driver such as a mid-range speaker. It should be appreciated that any number of loudspeaker drivers 112 may be included in device 100.

Phase plug 116 may be arranged to reduce echo cancellation, and to augment the relatively high frequency response associated with loudspeaker 108. That is, phase plug 116 reduces wave cancelling with respect to acoustic waves by reducing collisions between acoustic waves having a relatively high frequency. Phase plug 116 is acoustically coupled to acoustic waveguide 120.

FIG. 2 is a diagrammatic cross-sectional side-view representation of an overall speaker arrangement that includes an acoustic waveguide in accordance with an embodiment. An overall speaker arrangement 202 includes a loudspeaker driver 212 that is a part of an overall loudspeaker, a phase plug 216, an acoustic waveguide 220. Acoustic waveguide 220, which includes an open area 218, is positioned below loudspeaker driver 212. At least one open area 222 is arranged within phase plug 216, as is shown in more detail in FIG. 5. Open areas 222 of phase plug 216 are effectively located at least partially between closed areas 552. In one embodiment, closed areas 552 may be formed from, e.g., filled with, a plastic material. Open area 218 and open areas 222 of phase plug 216 provide space in which air particles may oscillate, and in which acoustic waves may propagate.

Acoustic waveguide 220 may be configured, as previously mentioned, to direct acoustic waves, or sound, substantially directly to users of a device that includes overall speaker arrangement 202. Acoustic waveguide 220 generally directs acoustic waves after the acoustic waves are propagated through open areas 218, 222. Thus, with respect to a device (not shown) such as a conference station in which overall speaker arrangement 202 is located, acoustic waves may be directed by acoustic wave guide 220 in directions with an x-axis component and/or a y-axis component. That is, acoustic waves may be guided by acoustic wave guide 220 along a path in at least one horizontal direction. It should be understood that although waves may be directed in any direction, as for example in a vertical direction or a direction with a z-axis component, acoustic waves are typically guided in at least one horizontal direction.

As shown, a top surface of acoustic waveguide 220 is curved. The shape of the curvature of the top surface of acoustic waveguide 220 may vary widely, and may depend upon a variety of different factors. The different factors may include, but are not limited to including, the directions in which acoustic waves are to be directed, a desired frequency response, and/or power requirements. In general, acoustic waves are to be directed such that energy is focused on a listener, or a user of a device that includes overall speaker arrangement 202, and such that substantially minimal energy is directed away from the listener. It should be appreciated that although acoustic waveguide 220 is shown as having a bottom surface that is substantially flat or planar, the bottom surface of acoustic waveguide 220 is not limited to being substantially flat or planar. For example, a bottom surface of acoustic waveguide 220 may have approximately the same curvature as a top surface of acoustic waveguide 220.

Typically, overall speaker arrangement 202 has an associated microphone that captures sound, e.g., sound that is local with respect to overall speaker arrangement 202. For example, a realtime communications device that includes overall speaker arrangement 202 typically also includes a microphone. FIG. 3 is a diagrammatic representation of overall speaker arrangement with an associated microphone in accordance with an embodiment. An overall speaker arrangement 202′ has an associated microphone 324, or a transducer that is arranged to convert sound into an electrical signal. As shown, microphone 324 is positioned at least partially over a curved top surface of acoustic waveguide 220. By positioning microphone 324 substantially above acoustic waveguide 220, the echo-cancelling performance associated with microphone 324 may be improved. When microphone 324 is positioned substantially above acoustic waveguide 220, microphone 324 may be positioned away from a path of energy directed by waveguide 220.

Although microphone 324 may preferably be positioned substantially above acoustic waveguide 220, microphone 324 is not limited to being placed substantially above acoustic waveguide 220. It should be appreciated, however, that when microphone 324 is positioned substantially below acoustic waveguide 220, or close to a bottom of overall speaker arrangement 202′, acoustic cone filtering and interference may be substantially minimized. Thus, the placement of microphone 324 with respect to overall speaker arrangement 202′ may vary depending upon the requirements of a particular system, as for example a conference phone, that includes microphone 324 and overall speaker arrangement 202′.

With reference to FIGS. 4A and 4B, the directionality of acoustic waves produced by a conference station such as a conference call will be described in accordance with an embodiment. FIG. 4A is a block diagram side-view representation of a conference phone that includes an acoustic waveguide that directs sound, and FIG. 4B is a block diagram top-view representation of the conference phone. A conference phone 430 that includes an acoustic waveguide is configured to direct acoustic waves 434, or sound waves, at one or more listeners. Acoustic waves 434, as shown, include at least one horizontal component. That is, each acoustic wave 434 is propagated in a direction along an x-axis and/or a direction along a y-axis. Acoustic waves 434 may also include a vertical component, i.e., a component relative to a z-axis, in addition to at least one horizontal component.

As a user (not shown) of conference phone 430 may be positioned next to conference phone 430 relative to the x-axis and/or the y-axis, acoustic waves 434 that are propagated in a direction along the x-axis and/or a direction along the y-axis are effectively directed substantially directly at the user. Thus, conference phone 430 provides acoustic waves to a user (not shown) efficiently.

FIG. 6 is a block diagram representation of a conference station that includes a speaker arrangement with an acoustic waveguide in accordance with an embodiment. A conference station 630 includes a speaker arrangement 600 which has an acoustic waveguide 620 that is arranged to direct acoustic sound waves in particular directions, e.g., substantially directly at a listener who is using conference station 630. Speaker arrangement 600 also includes a driver 672, e.g., a loudspeaker driver, that is arranged to convert a received signal into an acoustic sound wave, and may be acoustically coupled to acoustic waveguide 620.

Conference station 630 also includes a processor 660, logic 664, and a network interface 676. Logic 664 may include software and/or hardware logic, and processor 660 is configured to execute software logic. Conference call logic 668, which is included in logic 664, allows conference station 630 to be used as an endpoint of a conference call, and generally supports the ability for conference station 630 to dial into and to participate in a conference call using network interface 676. Network interface 676 may include at least one input/output port (not shown) that allows conference station 630 to connect to a communications network, e.g., telephone network or a network that supports voice over IP (VoIP). Through network interface 676, conference station 630 may connect to nodes on a communications network, e.g., a node such as a conference call server, such that signals may be exchanged between conference station 630 and the nodes. In general, nodes on a communication network may be endpoints associated with a conference call.

Conference station 630 also includes a microphone arrangement 678 that includes at least one microphone 624 arranged to capture sound from an environment around conference station 630. The position of microphone 624 with respect to speaker arrangement 600 may vary. As previously mentioned, microphone 624 may be positioned substantially above acoustic waveguide 620 relative to a vertical axis, e.g., to improve the echo-cancelling performance of conference station 630. It should be appreciated, however, that microphone 624 is not limited to being positioned above acoustic waveguide 620 and may be positioned below acoustic waveguide 620 relative to the vertical axis, e.g., close to a surface on which conference station 630 is placed, in an effort to reduce acoustic cone filtering.

Although only a few embodiments have been described in this disclosure, it should be understood that the disclosure may be embodied in many other specific forms without departing from the spirit or the scope of the present disclosure. By way of example, the location of a microphone in a conference phone relative to the location of an acoustic waveguide may vary widely. Some applications, or overall system specifications, may benefit from the placement of a microphone over an acoustic waveguide relative to a vertical axis. Other applications, or overall system specifications, may benefit from the placement of a microphone below an acoustic waveguide relative to a vertical axis.

The shape, e.g., curvature, associated with an acoustic waveguide may vary widely. Factors which may affect the shape of an acoustic waveguide may include, but are not limited to including, the size an overall speaker arrangement and/or the directions in which sound waves are to be directed.

While a waveguide has been described as being positioned substantially below a loudspeaker within a conference phone device, relative to a vertical axis, a waveguide may instead be placed substantially above a loudspeaker within a conference phone device, relative to a vertical axis, without departing from the spirit or the scope of the disclosure. For example, when a waveguide is positioned above a loudspeaker, a reflector may be used to effectively reverse the phase of sound waves coming from the loudspeaker.

The embodiments may be implemented as hardware and/or software logic embodied in a tangible medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals such as signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining a signal on an interface of a realtime communications device, the realtime communications device including an acoustic waveguide;
converting the signal to an acoustic wave;
propagating the acoustic wave; and
directing the acoustic wave using the acoustic waveguide.

2. The method of claim 1 wherein the realtime communications device is a conference station.

3. The method of claim 1 wherein the acoustic waveguide is configured to define a first open area, and wherein the realtime communications device includes a phase plug, the phase plug being configured to define a second open area, wherein propagating the acoustic wave includes propagating the acoustic wave through the first open area and through the second open area.

4. The method of claim 3 wherein the realtime communications device further includes a loudspeaker driver arranged to convert the signal to the acoustic wave, and wherein the loudspeaker driver and the phase plug are acoustically coupled to the acoustic waveguide.

5. The method of claim 1 wherein directing the acoustic wave using the acoustic waveguide includes directing the acoustic wave directly at a user using the acoustic waveguide, the user being a user of the realtime communications device.

6. An apparatus comprising:
means for obtaining a realtime communications signal;
means for converting the signal to an acoustic wave;
means for propagating the acoustic wave; and
an acoustic waveguide, wherein the acoustic waveguide is arranged to direct the acoustic wave along at least one particular path.

7. An apparatus comprising:
a network interface, the network interface being arranged to communicate on a network, wherein the network interface is further configured to obtain a signal from the network;
an acoustic waveguide; and
an arrangement, the arrangement being configured to transform the signal into an acoustic wave and to provide the acoustic wave to the acoustic waveguide, wherein the acoustic waveguide is configured to direct the acoustic wave in a path.

8. The apparatus of claim 7 wherein the path is a direct path to a user of the apparatus.

9. The apparatus of claim 7 wherein the acoustic waveguide includes a first surface arranged to direct the acoustic wave in the path, the first surface having a first curvature.

10. The apparatus of claim 9 further including:
a phase plug, the phase plug having at least one closed area and at least a first open area, wherein the acoustic waveguide defines at least a second open area, and wherein the acoustic wave is propagated through the at least first open area and the at least second open area.

11. The apparatus of claim 7 wherein the apparatus is a realtime communications device, and wherein the apparatus further includes:
logic operable to support a conference call, wherein the signal is obtained from an endpoint associated with the conference call.

12. The apparatus of claim 11 further including:
a microphone.

13. The apparatus of claim 12 wherein the acoustic waveguide includes a first curved surface arranged to direct the acoustic wave in the path, and wherein the microphone is positioned over the first curved surface relative to a vertical axis.

14. The apparatus of claim 7 wherein the path is a direct path to a user of the apparatus.

15. The apparatus of claim 7 further including:
an enclosure; and
a phase plug, wherein the arrangement includes a loudspeaker driver, the loudspeaker driver and the phase plug being mounted inside the enclosure.
